(19) United States
(12) Patent Application Publication
(10) Pub. No.: US 2025/0285429 A1
(43) Pub. Date: Sep. 11, 2025

(54) METHOD AND SYSTEM FOR IMAGING AND IMAGE PROJECTION USING INTEGRATED PHOTONIC COMPONENTS

(71) Applicant: Lumenuity Inc., Cabin John, MD (US)

(72) Inventors: Benjamin SHAPIRO, Cabin John, MD (US); Edo WAKS, Cabin John, MD (US)

(73) Assignee: Lumenuity Inc, Cabin John, MD (US)

(21) Appl. No.: 19/105,002

(22) PCT Filed: Aug. 21, 2023
(86) PCT No.: PCT/US2023/030742

§ 371 Date: Feb. 19, 2025

Related U.S. Application Data
(60) Provisional application No. 63/373,030, filed on Aug. 19, 2022.

(51) Int. Cl. G06V 10/88; G06V 10/143; G06V 10/147; G06V 20/20

(52) U.S. Cl. CPC G06V 10/88; G06V 10/143; G06V 10/147; G06V 20/20

(57) ABSTRACT

Device and methods for imaging and projecting scenes or objects are disclosed that incorporate photonic components. The devices include couplers and phase shifter elements and optical processing modules. Certain devices may be substantially planer and incorporated into various mobile system. Certain devices and method may be lensless or lack an operatively connected lens.

### CROSS-REFERENCE TO RELATED APPLICATION

This application claims the benefit of U.S. Provisional Patent Application No. 63/373,030, filed Aug. 19, 2022, which is incorporated by reference herein in its entirety.

### TECHNICAL FIELD

This application relates to optics, imaging and projection devices and imaging and projection methods. More specifically, this application relates to imaging and projecting devices and imaging and projection methods that can be incorporated into mobile devices, cameras, augmented reality systems, and virtual reality systems.

### BACKGROUND

Imaging technologies have gained significant importance in various fields. Small, high-performance, low-power cameras are desirable for mobile devices, smartphones, tablets, drones, and as optical imaging sensors for self-driving vehicles. Likewise high-performance, small, low weight and low power image projector systems are desirable for augmented and virtual reality (AR/VR) systems, for reasons of utility, user comfort, and battery life. In such AR/VR systems, light projection optics are attached to glasses, visors, or headsets and are used to project images into the user's eye or eyes.

These current imaging technologies typically contain lenses or other conventional focusing elements (such as curved mirrors) to either focus the light from the object to a sensor (imaging or camera systems) or to shape the light from light sources to a projection surface. For example, in AR/VR projection systems, light typically projects from a light source or sources (e.g. from a set of LEDs) into a user's eye, so that this light reaches the user's retina in-focus. This application usually requires lenses or curved mirrors in existing systems. Inclusion of lenses, and the distance required from lenses to sensor(s) (for imaging or camera systems) or from lenses to light sources (projection system) can increase the size and weight of these systems. Larger system sizes can lead to higher power requirements, decreased battery life, and to decreased user comfort and adoption.

Accordingly, there is always a need for improved imaging and projecting devices and methods.

### SUMMARY

This application discloses an integrated photonic circuit for imaging that can include a planar mounting substrate. One aspect is a mounting substrate or substrate (e.g. a silicon chip with a thin oxide layer) that incorporates a plurality of components including input couplers, input waveguides, optical phase shifter elements, an optical processing module, output waveguides, and detectors or a sensor or sensors. These components are arranged to capture incident light, process it through various optical manipulation stages, and form a focused image. This arrangement helps ensure processing efficiency and high-quality imaging.

This application also discloses an integrated photonic circuit for projecting images that can include a planar mounting substrate. The substrate (e.g. a silicon chip with a thin oxide later) can include a plurality of components including first couplers, input waveguides, optical phase shifter elements, an optical processing module, waveguides, and light sources. During projection, light progresses through the devices in the reverse direction, compared to during imaging or specific imaging embodiments. Now the components are arranged to accept light from light input sources, process it through various optical manipulation stages, output light, and form a focused image on an external projection surface.

Another aspect includes a substrate for optical processing, imaging, and projection, offering an innovative design for ultra-thin imaging and projection devices. Traditional imaging devices rely on lenses positioned at a specific distance from the sensor, governed by the focal length of the lens. Similarly, conventional projectors place lenses at a defined distance from the light source, again based on the focal length. As a result, these conventional devices are inherently constrained by a minimum thickness, preventing their incorporation into extremely thin designs (e.g., devices that are thinner than 0.5 mm). In contrast, specific embodiments of integrated photonic circuits can enable the optical components, detectors, and light sources to be aligned on a single plane, set on a mounting substrate that can be remarkably thin (e.g., less than 0.5 mm). This paves the way for imaging and projection devices with a drastically reduced form factor.

Another aspect includes an integration of various components onto a single substrate which can reduce the sizes of imaging and projecting devices across different industries. The compact design and strategic arrangement of elements make the design valuable in, among other things, mobile devices, cameras, augmented reality systems, and virtual reality systems.

Another aspect includes a mounting substrate to capture a scene having a plurality of first couplers that capture incident light on the substrate from the scene; a plurality of input waveguides receives the incident light, wherein each of the plurality of the first couplers guide the light into one of the plurality of input waveguides; a plurality of first optical phase shifter elements shift the phase of the light to produce phase shifted light; wherein the phase shift compensates for the variation in optical path length from a point on the object or the scene to the plurality of the first couplers and through the first waveguides; an optical processing module that transforms the phase shifted light into focused light; a plurality of output waveguides captures an in focused light; and a plurality of detectors captures the focused light to form an image. The optical processing module can have internal waveguides, internal phase shifters, and internal beamsplitters therein. The optical processing unit receives the shifted light; and the optical processing unit transforms the shifted light into in-focused light.

Another aspect includes embodiments in which lenses or a lens are omitted or unnecessary to the performance of the application. Certain embodiments can be lensless. The plurality of first couplers can capture the incident light without a lens.

Another aspect includes a mounting substrate to capture a scene having a plurality of first couplers that capture incident light on the substrate from the scene; a plurality of input waveguides receives the incident light, wherein each of the plurality of the first couplers guide the light into one of the plurality of input waveguides; a plurality of first optical phase shifter elements shift the phase of the light to produce phase shifted light; wherein the phase shift compensates for the variation in optical path length from a point on the object or the scene to the plurality of the first couplers and through the first waveguides; an optical processing module having internal waveguides, internal waveguides, wherein the optical processing module transforms the phase shifted light into focused light; a plurality of output waveguides captures an in focused light; and a plurality of detectors captures the focused light to form an image. The optical processing module can have internal waveguides, internal phase shifters, and internal beamsplitters therein, the optical processing module receives the shifted light; and the optical processing module transforms the shifted light into a focused light.

Another aspect includes a mounting substrate having an optical processing module having internal multi-mode interference devices therein. The optical processing module can receive the shifted light; and the optical processing module transforms the shifted light into in a focused light.

Another aspect includes a mounting substrate in which the substrate forms the image at the detectors using the light directly captured from the scene by the plurality of first couplers.

Another aspect includes a mounting substrate that forms the image using the light captured by the plurality of first couplers and the plurality of first optical phase shifter elements and the plurality of detectors.

Another aspect includes a mounting substrate in which the plurality of phase shifters produce a phase that is a quadratic function of the position of the plurality of first couplers that feeds light into the plurality of phase shifter.

Another aspect includes a substrate in which the optical processing module performs a discrete Fourier transform.

Another aspect includes a substrate in which the optical processing module is composed of internal beamsplitters, internal phase shifters, and internal waveguides.

Another aspect includes a mounting substrate in which the first plurality of optical phase shifters are configured to apply a phase shift which is a quadratic function of the position of the coupler that feeds the respective phase shifter.

Another aspect includes a mounting substrate in which the plurality of input couplers is evenly spaced along the substrate and the phase shifters apply phase shifts that are a quadratic function of the distance from one of the couplers.

Another aspect includes a mounting substrate in which the first optical phase shifters are configured to apply phase shifts of

$$Δθ = \frac{π}{λ L} {x}^{2} + \frac{π}{λ L} {y}^{2}$$

where x is the distance from the along the x-axis from the plurality of the first couplers to one of the plurality of the first couplers, y is the distance from the along the x-axis from one of the plurality of the first couplers to a first coupler of the plurality of couplers, L is the distance from the substrate to an object plane in the scene that will form a focused image, and is the wavelength of light.

Another aspect includes a mounting substrate in which the light reflects or emanates from the object to the plurality of first couplers.

A mounting substrate of claim 1, wherein each of the plurality of first couplers corresponds one of the plurality of plurality of first optical phase shifter elements and one of the plurality of input waveguides.

Another aspect includes a mounting substrate in which the plurality of first couplers, the plurality of input waveguides, and the plurality of first optical phase shifter elements are disposed on one plane on the substrate.

Another aspect includes a mounting substrate in which array of first couplers couple light from an object into an array of waveguides, followed by an array of phase shifters that adjust the phase of the field in each waveguide, followed by a series of beamsplitters and phase shifters to form an image at an output set of waveguides.

Another aspect includes a mounting substrate in which the plurality of detectors receive light from couplers on the substrate.

Another aspect includes a mounting substrate in which a plurality of input waveguides are configured to direct light to the a plurality of first optical phase shifter elements.

Another aspect includes a mounting substrate in which the detector is an image sensor.

Another aspect includes a mounting substrate in which a series of spectral filters select different color light before the detector.

Another aspect includes an imaging device having a chassis, a mounted substrate to capture a scene having (i) a plurality of first couplers that capture incident light on the substrate from the scene; (ii) a plurality of input waveguides receives the incident light, wherein each of the plurality of the first couplers guide the light into one of the plurality of input waveguides; (iii) a plurality of first optical phase shifter elements shift the phase of the light to produce phase shifted light; wherein the phase shift compensates for the variation in light path length from a point on the object or the scene to the plurality of the first couplers and through the first waveguides; (iv) an optical processing module having input waveguides, output waveguides, wherein the optical processing module transforms the phase shifted light into focused light; (v) a plurality of output waveguides captures an in focused light; and (vi) a plurality of detectors captures the focused light to form an image processor; and memory. The mounted substrate may not have an operatively connected lens. The imaging device can be a camera. The device can have a display.

Another aspect includes an imaging device in which the optical processing module has internal waveguides, internal phase shifters, and internal beamsplitters therein, the processing module receives the shifted light; and the optical processing module transforms the shifted light into in a focused light.

Another aspect includes an imaging device in which the substrate forms the image using the light captured by the plurality of first couplers and the plurality of first optical phase shifter elements and a plurality of detectors.

Another aspect includes an imaging device in which the plurality of first couplers captures the incident light without an operatively connected lens.

Another aspect includes an imaging device in which the phase shifters produce a phase that is a quadratic function of the position of the coupler that feeds light into the phase shifter.

Another aspect includes an imaging device in which the plurality of input couplers is evenly spaced along the substrate and the phase shifters apply phase shifts that are a quadratic function of the distance from the center waveguide.

Another aspect includes an imaging device having a display and an image sensor, wherein the image sensor is operatively connected to the plurality of detectors.

Another aspect includes an imaging device in which a series of spectral filters filter different color light before each detector.

Another aspect includes an apparatus for generating one or more Augmented Reality (AR) objects having a light source and a mounting substrate as described herein. Another aspect includes a method of projecting an image or scene having the steps of generating focused light from a plurality of light sources; capturing the focused light using a plurality of first waveguides; transmitting the focused light to an optical processing module that transforms the focused light to shifted light; transmitting the light from the optical processing module to a plurality of phase shifters operatively connected to first output couplers by second waveguides; wherein the phase shifters compensate for the variation in optical path length from the output couplers to a point on projection plane or scene, and the output couplers emit the light to the projection plane or scene to form a focused image. The compensation can performed by a plurality of phase shifters.

Another aspect includes methods of capturing an image having the steps of capturing light using a plurality of first couplers; compensating for the phase shift acquired by the light as it travels from a location in the scene to the first couplers; transmitting the light to an optical processing module, wherein the optical processing transforms the shifted light into in a focused light; transmitting the focused light from the optical processing module to a plurality of detectors using a plurality of output waveguides; and forming an image using the focused light. The compensation can be performed by a plurality of phase shifters. The image can be formed by capturing and assembling the focused light from the plurality of detectors. The image sensor can be a complementary metal oxide semiconductor (CMOS) camera sensor or other image sensor.

Another aspect includes a mounting substrate to project an image on a plane having a plurality of first light sources that generate focused light on the substrate; a plurality of input waveguides that receive the generated light; an optical processing module having second input waveguides, and first output waveguides (the optical processing module can transform the focused light into phase shifted light); a plurality of first optical phase shifter elements receive the light from the optical processing module and produce a phase shift light; wherein the phase shift compensates for the variation in light path length from a point on the object or the scene to the plurality of the first couplers and through the first waveguides; and a plurality of output waveguides receives the light from the phase shifters and emits it out of the plane of the device. Each of the plurality of the first couplers can project an image.

Another aspect includes a mounting substrate to project an image on a plane in which the optical processing module has internal waveguides, internal phase shifters, and internal beamsplitters therein, the optical processing module receives the shifted light; and the optical processing module transforms the shifted light into in a focused light.

A substrate of claim 50, wherein the optical processing module has internal multi-mode interference devices therein, the optical processing module receives the shifted light; and the optical processing module transforms the shifted light into in a focused light. The substrate can form the image at the detectors using the light directly captured from the scene by the plurality of first couplers. The plurality of first couplers can capture the incident light without a lens.

Another aspect includes a mounting substrate to project an image on a plane in which the plurality of phase shifters produce a phase that is a quadratic function of the position of the plurality of first couplers that feeds light into the plurality of phase shifter.

Another aspect includes a mounting substrate to project an image on a plane in which the optical processing module performs a discrete Fourier transform.

Another aspect includes a mounting substrate to project an image on a plane in which the first optical phase shifters are configured to apply phase shifts of

$$Δθ = \frac{π}{λ L} {x}^{2} + \frac{π}{λ L} {y}^{2}$$

where x is the distance from the along the x-axis from the plurality of the first couplers to one of the plurality of the first couplers, y is the distance from the along the x-axis from one of the plurality of the first couplers to a first coupler of the plurality of couplers, L is the distance from the substrate to an object plane in the scene that will form a focused image, and is the wavelength of light.

Another aspect includes a mounting substrate to project an image on a plane in which each of the plurality of first couplers corresponds one of the plurality of plurality of first optical phase shifter elements and one of the plurality of input waveguides.

Another aspect includes a mounting substrate to project an image on a plane in which the plurality of first couplers, the plurality of input waveguides, and the plurality of first optical phase shifter elements are disposed on one plane on the substrate.

Another aspect includes a mounting substrate to project an image on a plane in which the plurality of detectors receive light from couplers on the substrate.

Another aspect includes a mounting substrate to project an image on a plane in which each of the plurality of input couplers has different portion of the scene.

Another aspect includes a mounting substrate to project an image on a plane in which a series of spectral filters filter different color light before the detector

### BRIEF DESCRIPTION OF THE DRAWINGS

FIG. 1 shows the components and configuration for the elements of a specific embodiment of a one-dimensional (1D) imaging device according to this disclosure.

FIG. 2 is a perspective view of the embodiment shown in FIG. 1 showing light rays scattering off of or emanating from a point on an object and exciting the input couplers.

FIG. 3 shows another specific embodiment of an imaging device having output couplers together with an adjacent sensor layer.

FIG. 4 shows a specific embodiment of an imaging device illustrating the optical processing module (‘F’, 105), which has waveguides, phase shifters, and beamsplitters.

FIG. 5 shows a specific embodiment of a two-dimensional (2D) imaging device according to this disclosure.

FIG. 6 is a perspective view of the embodiment shown in FIG. 5 showing light rays scattering off or emanating from two sample points on an object.

FIG. 7A shows an example object that is the subject of the simulation shown in FIG. 7B.

FIG. 7B shows the resulting image from a ray tracing simulation. For the object of FIG. 7A, light rays are simulated through the imaging device in FIGS. 5 and 6, but with 64×64=4,096 imaging channels or pixels . . .

FIG. 8 shows an exemplary thin camera including the embodiment shown in FIG. 5.

FIG. 9 shows an exemplary projector chip or substrate (100) incorporating a modification of the embodiment shown in FIGS. 5 and 6.

FIG. 10 shows another embodiment of a projection device illustrating N×M imaging channels (or ‘pixels’) to illustrate scale.

FIG. 11A shows an example image encoded on the light sources in FIG. 9.

FIG. 11B shows the resulting image from a ray tracing simulation in which light rays are simulated through the projection device in FIG. 10, with N=M=64 imaging channels (or pixels).

FIG. 12 shows a method for calculating a 2-dimensional Fourier transform by a sequence of 1-dimensional Fourier transforms.

FIG. 13 shows an exemplary method of capturing an image.

FIG. 14 shows an exemplary method of projecting an image

### DETAILED DESCRIPTION

This application discloses imaging and projection devices and methods for imaging objects and projecting images, through the use of integrated photonic devices composed of a thin layer on a chip. Specific embodiments of the invention include an integrated photonic device comprising a chip or mounted substrate having photonic couplers, phase shifters, an optical processing module, detectors and/or light sources, connected by waveguides. The phase shifters can compensate for different phases of light that can arrive at the photonic couplers from a substantially single location on an object. Thereafter, the optical signal processing module can apply a transformation to the light (e.g. a Fourier transformation). Together, these elements allow a sensor or detector to receive a focused image. These elements also allow light sources to project a focused image on a surface that is external to the photonic device.

Further, specific embodiments include devices and methods allow for imaging and image projection without a need for conventional, operatively connected, focusing elements such as lenses or curved mirrors. Specific embodiments include lensless imaging systems or cameras, in which lenses or a lens are omitted or are unnecessary to enable collecting in-focus images of an object or a scene. Likewise, other embodiments include lensless projection systems, in which lenses or a lens are omitted or are unnecessary to enable projecting an in-focus image.

An operatively connected lens refers to a lens that is physically or functionally connected to a device or system in a way that it can perform a specific task or function within that device or system. This connection allows the lens to interact with other components or systems to achieve a desired outcome. The term is often used in various technical and scientific contexts. In essence, an operatively connected lens is not just a standalone lens but an integral part of a larger system or device, where it plays a role in achieving the intended functionality. A device that is lensless as used herein does not have an operatively connected lens.

### Imaging Examples

One specific embodiment includes a mounting substrate that is a compact and integrated device that facilitates efficient optical imaging. In this arrangement, all of the elements of this embodiment can lie substantially on the same plane making the device thin. This may be in contrast to many conventional imagers and projectors.

The optical components in specific embodiments can be integrated into a single substrate, which can reduce the need for complex and bulky optical setups. The arrangement of optical phase shifter elements and processing modules enhances the signal manipulation capabilities, enabling imaging (and image projection) using devices with reduced size and thickness.

Specific imaging embodiments can have first couplers: The mounting substrate includes a plurality of first couplers positioned to capture incident light from an object onto the substrate. These first couplers are arranged to couple light onto the substrate. The substrate can have input waveguides integrated into the substrate to receive the incident light captured by the first couplers. Each first coupler directs the light into a corresponding input waveguide.

Positioned along the input waveguides are optical phase shifter elements. These phase shifter elements shift the phase of the light, producing phase shifted light. The phase shift of each phase shifter is a quadratic function of the position of the coupler on the mounted substrate connected to that phase shifter. Specifically, if a coupler is located at position (x, y) on the mounted substrate, the phase shifter connected to that substrate applies a phase shift of

$$Δθ = {θ}_{0} - \frac{π}{λ L} {( x - {x}_{0} )}^{2} - \frac{π}{λ L} {( y - {y}_{0} )}^{2} ,$$

where x₀ and y₀ denote the center coordinates of the coupler array along the x-axis and y-axis, λ is the wavelength of light, and θ₀ is a fixed offset that may be chosen for convenience and does not affect the performance of the device. Each phase shifter is selected to apply the specific phase shift determined by this relation.

The length L is the distance between the object plane and the imager. It is an adjustable parameter that can be selected to produce a focused image of a desired object plane located at a specified distance away from the imager. When an object is located on the object plane at the correct distance, the phase shifter will produce phase shifts that compensate for the phase of light coming from substantially a single location on an object to that specific input coupler. This phase compensation will enable a focused image on the imager. Objects located at other object planes at different distances may not receive the correct phase compensation and therefore may not form a focused image. Selecting different values of L will result in an imager that produces an in-focus image of an object plane at different distances away from the imager. By using adjustable phase shifters, such as electro-optic or thermo-optic modulators, one may implement an imager where one can adjust the object plane that forms a focused image. One may change the phase shifters to focus on object planes at various depths from the imager without moving parts.

In certain embodiments, functions other than quadratic ones may be employed with the substrate 100. These alternative functional relationships can be utilized to counteract aberrations and distortions. For instance, while the quadratic function serves optimally in the paraxial limit, where the object is positioned at a large distance from the imager relative to the imager size, it might induce image distortions and result in suboptimal imaging when the object is closer. This is similar to the shortcomings of traditional lens-based systems, which are prone to aberrations like spherical aberrations and coma, among others. Thus, to enhance image quality, functions other than quadratic might be preferred. Furthermore, the functional relationship of the phase shift can be fine-tuned to address other imperfections, including chromatic aberrations and component deficiencies.

The substrate 100 can have an optical processing module. This optical processing module can have waveguides that receive light from the phase shifters, and a network of beamsplitters, phase shifters, and waveguides to transform the light, and a set of waveguides that receive the light from the processing module after it has been processed and send it to detectors. The processing module receives the shifted light from the first optical phase shifter elements, performs a Fourier transform on the input light, and then channels the resulting light to output waveguides and detectors. After the first phase shifters, each point on the object is encoded by a relative phase shift. Through the Fourier transform operation, the processing module converts this relative phase to spatial information by channeling light for each relative phase to a different exit waveguide. The optical processing module can perform Fourier and other appropriate transformation through a combination of beamsplitters, phase shifters, waveguides, and other on-chip components (filters, optical cavities or resonators, gratings, etc.). This enables an image of the object to be present at the output of the optical processing module.

In certain embodiments, transformations other than a Fourier transform may be employed. These alternative transforms can be utilized to counteract aberrations and distortions. For instance, while the Fourier transforms serve optimally in the paraxial limit, they might induce image distortions and result in suboptimal imaging when the object is closer. Thus, to enhance image quality, transforms other than the Fourier transform be preferred. Furthermore, the transform can be fine-tuned to address other imperfections, including chromatic aberrations and component deficiencies.

The substrate can have output waveguides. The mounting substrate further incorporates a plurality of output waveguides to capture the focused light produced by the optical processing module. These output waveguides ensure that the processed light is efficiently directed to subsequent stages.

The substrate can have on-chip detectors: Detectors can be integrated into the substrate to capture the focused light passing through the output waveguides. Or they can be placed adjacent to the chip or substrate, in which case output couplers would also be included on the substrate. The captured light forms an image at the detectors, allowing for thin form-factor imaging applications.

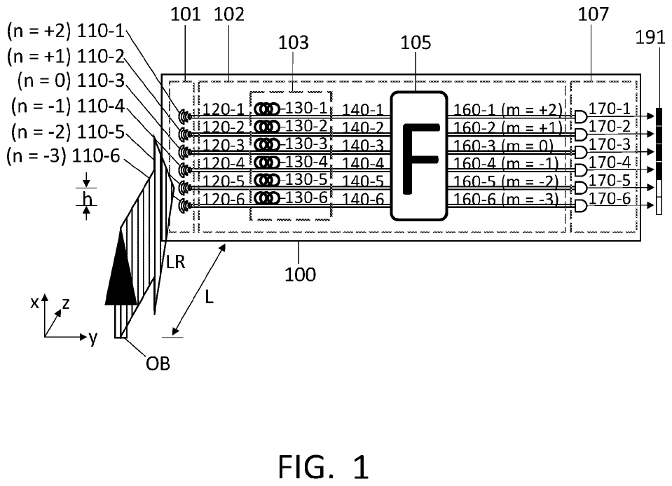

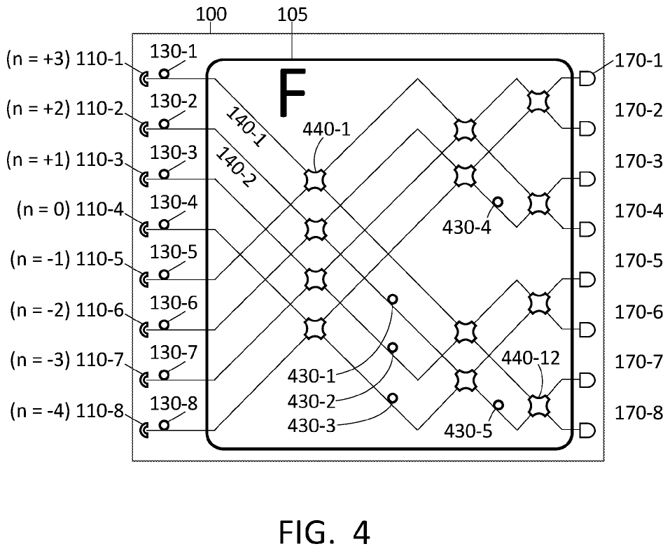

FIG. 1 illustrates a specific embodiment of an imager. This imager is an integrated photonic circuit on a mounted substrate (100). The circuit guides and processes light using light couplers (110), waveguides (120, 140, 160), phase shifters (130), beamsplitters (contained within 105, see FIG. 4, 440), and detectors (170). For example, the mounted substrate may be composed of a silicon carrier wafer with a thin (e.g. 3 μm) layer of silicon dioxide. The optical components can be composed of a thin layer of silicon nitride that is patterned into an appropriate geometry. For example, a region of the silicon nitride layer may be patterned into a thin ridge to form a waveguide. Alternately, it may be patterned into a grating composed of a periodic array of thin ridges to form a coupler. Beamsplitters may be formed by bringing two waveguides into close proximity and allowing them to evanescently couple, forming a directional coupler. By selecting the length of the directional coupler one can create a beamsplitter with arbitrary splitting ratios. Phase shifters can be formed by adjusting the length of a waveguide, or alternately by adjusting its effective index by making the waveguide wider or narrower. The materials and structures described here are just examples, and there are many other examples of materials and device structures that can be used. All of the device structures can also be fully encapsulated in another dielectric. For example, after the silicon nitride layer is patterned to form optical devices, an additional layer of silicon dioxide or another material can be deposited on top of the structure to encapsulate them.

The detectors may be composed of any device that converts light to electricity. For example, they may be composed of CMOS detectors, CCD arrays, PIN diodes, avalanche photodiodes, or photomultiplier tubes. These are only examples and there are many other devices that serve as detectors that can be used. The light from the output waveguides of the optical processing module may be coupled to the detectors in a variety of ways. Examples include butt-coupling the detectors to the edge of the waveguide, evanescent coupling, using a grating coupler to scatter light to a detector that is contacted to the surface of the chip. The detector could also be formed directly out of the same material as the other optical components. For example, a certain region of a waveguide can be directly doped to form a PIN diode.

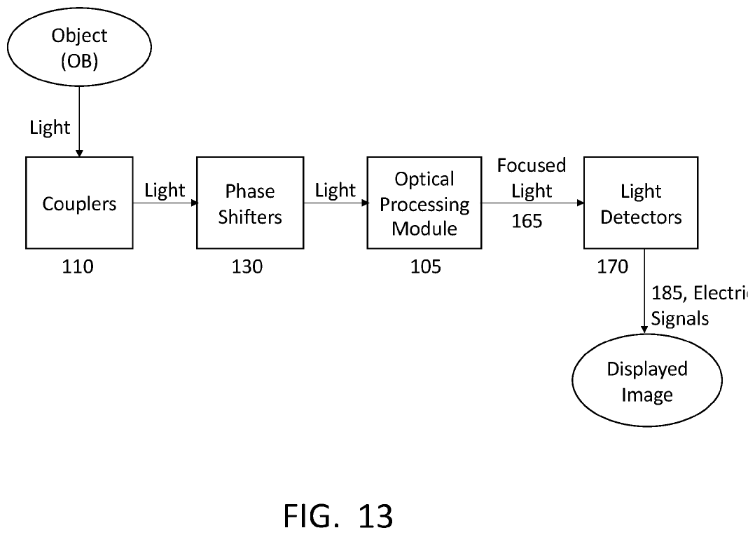

FIG. 13 shows an exemplary method of capturing an image. The steps can include Capturing light using a plurality of first couplers 110; transmitting the light to a plurality of first optical phase shifter elements 130 using a plurality of input waveguides; transmitting the light from the plurality of first optical phase shifter elements to an optical processing module 105, wherein the optical processing module has input waveguides, output waveguides, and can contain beamsplitters, phase shifters, and additional waveguides that transform the shifted light into focused light 165; transmitting the focused light from the optical processing module to a plurality of detectors 170 using a plurality of output waveguides; and sending an image (for example to a display) by converting the detected light to electrical signals 185. Step 185 can be achieved using detectors or sensors.

FIG. 1 illustrates an imaging system capturing data in a single dimension. A one-dimensional slice (image 191) can be formed of a two-dimensional object (OB). Unlike traditional two-dimensional (2D) imaging devices, which capture and display information in both the horizontal and vertical dimensions, a (1D) imaging device focuses on capturing data along a single axis, typically in the form of a line or a sequence of points. By mounting a one-dimensional imager on a movable or rotating platform, it can gather two-dimensional image data. Expanding imaging from one to two dimensions will be discussed subsequently.

The imaging device of FIG. 1 has a number of on-chip regions: a light collection region (101); a light processing region (102), which itself contains a phase shifting region (103) and an optical transformation region (105); and an image formation region (107). The light collection region (101) has a plurality of first input light couplers (110). The light processing region (102) has a plurality of input waveguides (120), a plurality of phase shifters (130) along these waveguides, an optical processing module (105), a plurality of output waveguides (160), and light detectors (170). This device can be substantially planar, meaning the elements and regions can be implemented in or on a planar surface, for example in or on a thin integrated photonic chip. This device does not contain any lenses or other conventional focusing elements (such as curved mirrors), and hence the entire imager (100) can fit into a thin form factor.

In the device of FIG. 1, each input coupler (110) channels light into its respective waveguide. Such light input couplers can be realized through various techniques, such as grating couplers, edge couplers, angled mirrors, or plasmonic nanostructures. These examples merely represent elements that introduce light from an out-of-plane direction into the waveguide. It is important to note that any device capable of receiving light incident on the chip and directing it into a guided mode of the waveguide can serve this purpose.

Waveguides (120) channel light through the device. Specifically, the channel the light from the input couplers (120) to the phase shifters (130). On-chip waveguides can be realized by a number of ways. As one example, a thin high dielectric material (e.g. silicon nitride) can be patterned into a thin ridge. This thin ridge may sit on or be encapsulated by a lower dielectric material (e.g. silicon dioxide). Light in the high dielectric region is guided by total internal reflection. Waveguides may be single mode or multi-mode. They can support transverse electric (TE) or transverse magnetic (TM) modes, or both.

The phase shifters (130) in the phase shift region (103) are configured to apply specifically prescribed phase shifts. In particular, they can apply phase shifts that correspond to a substantially quadratic function of the position of the input coupler that coupled light into the waveguide connected to the phase shifter. Specifically, for a grating or input coupler at position x, the connected phase shifter applies a phase shift of

$$Δθ = {θ}_{0} - \frac{π}{λ L} {( x - {x}_{0} )}^{2}$$

where x₀ is the defined as the center of the coupler array, L is the distance between the object plane and the imager, A is the wavelength of light, and θ₀ is a nominal offset that can be selected for convenience. Such a quadratic relation enables the imager to operate effectively when the object (OB) is at a large enough distance L from the imaging substrate (100) for the paraxial limit to be true (discussed in more detail below). The quadratic relation can be modified, to enable effective imaging outside the paraxial limit (when the object is close to the imager), and doing so is disclosed and anticipated.

For the quadratic relation, an example index numbering for the couplers is annotated in parentheses on the left of FIG. 1 (the ‘n= . . . ’ annotations). Using this notation, the position of the n′th input coupler is denoted by x=nh. We define n=0 as the center of the chip. In this case the quadratic relation between the specific phase shifts Δθ and the index number can now be prescribed according to equation (1)

$$Δθ ( n ) = {θ}_{0} - \frac{π {h}^{2}}{λ L} {n}^{2} \qquad ( 1 )$$

Here Δθ is the prescribed phase shift for phase shifters (130), n is the index for the phase shifter element number (e.g. n=+2, +1, 0, −1, −2, −3 respectively for phase shifters 130-1, 2, 3, 4, 5, 6), h is the distance between the input couplers, L is the distance between the imager and the object, and A is the wavelength of light. (The parameter θ₀ is a nominal offset that can be selected as convenient.)

Table 1 below lists example quadratic prescribed phase shifts for the 6-channel exemplary device of FIG. 1. (In the table, in parentheses, example prescribed numerical values of quadratic relation phase shifts Δθ are further listed. The values are for the case where the object (OB) is L=1 meter away from the imaging device 100 along the −z axis, the spacing between input couplers h=50 micrometers, and a wavelength of light λ=532 nanometers is considered, and the nominal offset angle θ₀ is set to zero.)

TABLE 1
Exemplary prescribed phase shifts for the phase shifters
(130-1, 130-2, 130-3, 130-4, 130-5, 130-6) shown in FIG. 1.

| Phase Shifter | Channel | Exemplary Prescribed Phase Shift |
|---|---|---|
| Label Number | Index | (with numerical values for a specific |
| in FIG. 1 | Number n | example case noted in parentheses) |
| 130-1 | n = +2 | $Δ θ = {θ}_{0} - 4 \frac{π {h}^{2}}{λ L} ( = - 3.38 degrees )$ |
| 130-2 | n = +1 | $Δ θ = {θ}_{0} - 1 \frac{π {h}^{2}}{λ L} ( = - 0.85 degrees )$ |
| 130-3 | n = 0 | Δθ = θ₀ |
| 130-4 | n = −1 | $Δ θ = {θ}_{0} - 1 \frac{π {h}^{2}}{λ L} ( = - 0.85 degrees )$ |
| 130-5 | n = −2 | $Δ θ = {θ}_{0} - 4 \frac{π {h}^{2}}{λ L} ( = - 3.38 degrees )$ |
| 130-6 | n = −3 | $Δ θ = {θ}_{0} - 9 \frac{π {h}^{2}}{λ L} ( = - 7.61 degrees )$ |

There are multiple ways to effectively define such a quadratic relation for the specifically prescribed phase shifts. For example, the relation could also have been defined by using the coupler (110) distance from the chip centerline, instead of using the index n. There can be other nearby relations (e.g. higher order polynomials, trigonometric functions, conic functions, etc.) that will give a distribution of prescribed phase shifts that are approximately or substantially equal to the phase shifts specified by a quadratic relation. Or the relation can be defined by selecting it so that it will substantially compensate for the variation in light path length from a location on the object to the input couplers. For example, such a selection can be made when the object is closer to the camera (L is small in FIG. 1), and the paraxial limit does not hold. Using such alternate relations is anticipated and disclosed.

Next, the optical processing module (105) transforms the light. This transformation region can be realized by a network of waveguides (internal), beamsplitters (internal), and phase shifters (internal). In particular, the transformation can be a discrete Fourier transform. A Fourier transform enables the imager to operate effectively in the paraxial limit. This optical processing module can be adjusted away from a Fourier transform, for example to enable the system to work outside the paraxial limit (discussed later), or to rectify imperfections in phase shifts, or potential distortions. So modifying the optical processing module is anticipated and disclosed. At the exit of the optical processing module (105), a focused image has been formed in the exit waveguides (160).

The exit waveguides deliver the light to detectors. Light detectors (170) can be realized in multiple ways. They could be composed of any element that converts light to electrical signal, such as CCD (charge coupled device) arrays, CMOS (complementary metal-oxide-semiconductor) arrays, avalanche photodiodes, or bolometers. Other elements that can measure light could also be used. The detectors could be placed on the substrate (100) as illustrated in FIG. 1. Or they could be placed next to the edge of the substrate (butt-coupled to it).

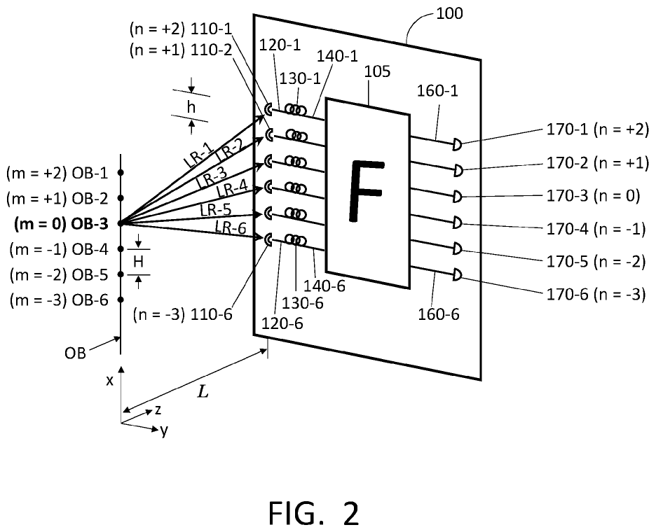

FIG. 2 is now used to describe and explain the progression of light through the device in more detail. This explanation is for the case when the imager is operating within the paraxial limit. This limit, commonly understood in imaging systems, arises when the object is positioned far enough from the imager so that all rays emitted from the object strike the imager at only small angles relative to the optic axis. Specifically, if we define the angle θ as the angle between any incident ray and the optic axis, we can make the simplifying approximations of sin (θ)=θ and cos (θ)=1. Many imaging systems are designed under the paraxial assumption, as it holds true for most optical systems. It is important to note that our disclosure is not confined to the paraxial limit. The imager can also operate beyond this limit but may exhibit degraded imaging performance. By modifying the quadratic relation and optical image processing module to correct for light phase shifts from points on the object in the case of light rays with a wider (no longer small) angles relative to the optical axis, it may be possible to achieve better imaging performance outside the paraxial limit. Doing so is anticipated and disclosed.

FIG. 2 shows the substrate 100 together with an object (OB) with 6 points (OB-1, . . . , 6) indexed by m=−3, −2, −1, 0, +1, +2. While the object (OB) is composed of many points, the six exemplary points illustrate light path from the object OB to the couplers.

On the right of the figure, the index n is used to number each of the device channels. First consider the point (OB-3, m=0) on the object (OB), since this point is at the same height as the centerline of the chip. In the paraxial limit, the object light point source corresponding to m=0 emits light rays that excite each of the couplers with nearly equal amplitude. These rays, however, each excite the coupler with different light phases because the optical path from the source to each coupler has slightly different length. One can show that in the paraxialg limit the relative phase Δϕ(n) of the light exciting coupler n (i.e. the phase difference between the light at coupler n≠0 and the coupler n=0) are given by the quadratic function

$$Δϕ ( n ) = \frac{π {h}^{2}}{λ L} {n}^{2} ,$$

where h is the distance between adjacent couplers, L is the distance between the source at m·0 and the coupler n=0, and λ is the wavelength of light. To compensate for these different phase shifts we set the phase shifters to apply the phase shift Δθ(n) given by equation (1) noted earlier. If this compensation is applied, then the light from this centerline point (OB-3, m=0) will arrive at the optical phase shifter (‘F’, 105) with equal phase, across all 6 waveguides.

Now consider the other m #0 points on the object (OB). In the paraxial limit, source m sends light into all of the waveguides (120) with nearly equal amplitude, but with different phases. After the phase shifter array (130), the relative phase between the light at waveguide n t 0 and waveguide n=0 is given by

$$ΔΦ = - \frac{π hH}{L λ}$$

mn where H is the distance between the object light sources as illustrated in the figure, and all other parameters are as previously defined.

Image focusing will occur if system parameters are selected to satisfy the equation

$$L = \frac{NhH}{2 λ} \qquad ( 2 )$$

where N is the total number of couplers in the imager (i.e. the total number of image pixels). In this case, object point m generates a field in the n′th waveguide given by

$${E}_{n} = {A}_{m} {e}^{- i \frac{π}{N} mn} ,$$

where Eₙ is the amplitude of the field traveling in the coupler and Aₘ is proportional to the intensity of the m′th point and the efficiency of the coupler. It can see from this relation that the amplitude in the waveguides is a periodic function with frequency πm/N. Thus, the position of the object point is encoded into the frequency of oscillation of the amplitudes of light in the waveguides, and can be extracted using a Fourier transform.

The focusing condition specifies the distance at which the imaging system can generate a sharp image. Objects outside this distance (outside the focal plane) will be out-of-focus. Hence this photonics imager works similarly to traditional lens-based systems. In such systems, a sharp image is formed on the sensor when the object is at the right distance, but any deviation from this distance results in blurriness. However, unlike traditional systems where the lens and the image plane are distinct, in this design, all components are primarily aligned on the imaging plane, ensuring a predominantly thin device profile.

Hence the purpose of the phase shifters (130) and the quadratic phase specification (equation (1) and Table 1) is to ensure that light from each location on the object arrives with the appropriate relative phase, across all waveguides (140), before it enters the optical processing module (105). At the entrance to (105), each location on the object is encoded by this relative phase of the light.

The optical processing module (105) implements a discrete Fourier transform. The Fourier transform relates the light amplitude in the module inputs (140) and outputs (160) by the relation

$$g [ n ] = {\sum }_{j = 0}^{N} f [ j ] {e}^{i \frac{π}{N} jn} .$$

In the above equation g[n] is the amplitude of the field amplitude propagating in the n′th output waveguide (140) and f[j] is the field amplitude propagating in the j′th input waveguide (160).

A optical processing module which executes a discrete Fourier transform between input and output waveguides is a recognized concept in the field of photonics. Such a module can comprise an array of beamsplitters and phase shifters, as detailed by Mahric (“Discrete Fourier transforms by single-mode star networks”, Vol. 12, Issue 1, pp. 63-65 (1987), https://doi.org/10.1364/OL.12.000063) and Siegman (“Fiber Fourier optics”, Vol. 26, Issue 16, pp. 1215-1217 (2001), https://doi.org/10.1364/OL.26.001215). Alternatively, it can be realized through multi-mode interference devices (e.g. Zhou, “All-Optical Discrete Fourier Transform Based On Multimode Interference Couplers”, Volume: 22 Issue: 15, 2010). These instances are merely illustrative of the various physical forms a processing module can take. Other methods to achieve the discrete Fourier transform exist, and hence could also be integrated into our imaging embodiment.

The disclosure also encompasses scenarios wherein the processing module implements transformations distinct from the Fourier transform, yet effectively concentrates light from each individual points on the object primarily onto a singular waveguide. In particular, when the imaging system operates beyond the paraxial limit, alternative transformations may offer enhanced imaging outcomes. Adjustments to the transformation capability of the processing module (105) to rectify aberrations arising from deviations from the paraxial limit, imperfections in phase shifts, or other potential distortions, are anticipated and disclosed.

Points that are located on the object at positions x>hN/2 and x<−hN/2 will wrap on the image sensor. For example, in FIG. 2, a point at position m=+3 could wrap to image sensor pixel n=−3, causing distortion. This effect can be eliminated by using couplers that selectively couple a restricted range of angles. This ensures that object points beyond the field of view do not effectively transmit light to the couplers. Methods to control the angular sensitivity of input couplers such as grating couplers are well known, and the angular sensitivity can be controlled very accurately by proper computational design of the grating periodicity and shape.

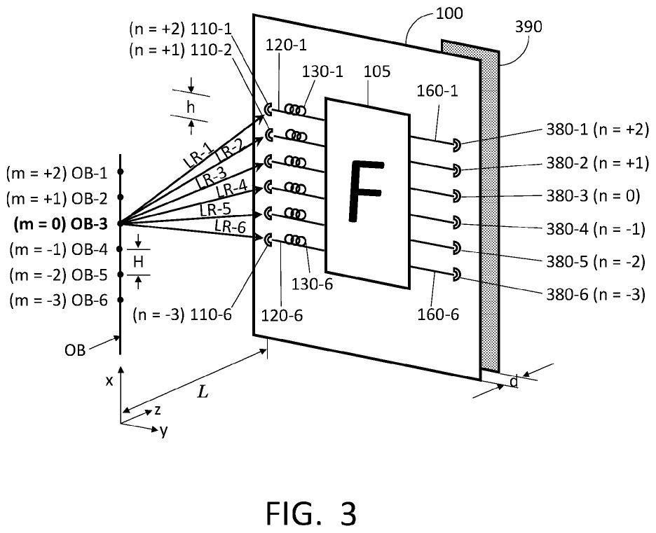

FIG. 3 shows another embodiment of a device for imaging in one-dimension. Here the in-plane detectors (170-1, 2, . . . , 6) of FIGS. 1 and 2 have been replaced by light output couplers (380-1, 2, . . . , 6) in FIG. 3. In addition, a sensor layer (390) has been placed adjacent to these light output couplers (either immediately adjacent, or with a gap ‘d’). In FIG. 3 this sensor layer is shown behind the mounting substrate (100), but if desired it can be placed in front.

In FIG. 3, after light from the object has been processed by the input couplers (110), the phase shifters (130), and the optical processing module (105), it emerges along the output waveguides (160). At this stage, the image has already been formed, but not yet converted from light to an electrical signal. Previously (FIGS. 1 and 2) each such waveguide sent light to in-plane light detectors (170), which converted the image from light to an electrical signal. Now instead, the light would be sent to light output couplers (160). These would send light out from the substrate or chip (100) to the adjacent light sensor layer (390). This sensor layer (390) would convert the generated light image to electrical signals, which could be stored or displayed to the user. The sensors in the light sensor layer can be comprised of various sensor embodiments including CMOS (complementary metal-oxide-semiconductor) detectors, CCD (charge coupled device) detectors, avalanche photodiodes, or photomultiplier tubes. These are only exemplary cases, and it should be understood that other elements that convert light to electrical signal could also be used.

FIG. 4 shows an exemplary optical processing module contained in a one dimensional imager (105). Photonic element placements and settings for the processing module implementing a discrete Fourier transform are already known in prior-art. This specific embodiment shown in FIG. 4 uses the layout of elements disclosed in A. E. Siegman, “Fiber Fourier optics,” Opt. Lett. 26, 1215-1217 (2001). In that Fourier region, there are 5 phase shifters (labeled 430), 12 beamsplitters (here labeled 440), and interior connecting waveguides (labeled 140). The phase delays disclosed in Siegman are: π/4 radians (45 degrees) at 430-3; and π/2 radians (90 degrees) at 430-2, 430-4, 430-5; and 3π/4 radians (135 degrees) at 430-1

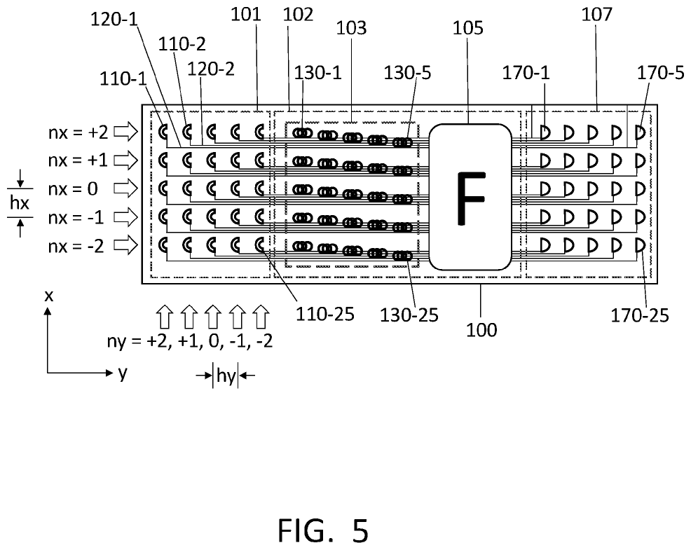

FIG. 5 shows a representative embodiment of the imaging system, for imaging in 2 spatial dimensions. The embodiment now uses a two dimensional grid of couplers to achieve 2 dimensional imaging. The imaging device or substrate (100) of FIG. 5 has the same number of regions as previously in FIG. 1 for one-dimensional imaging. Again there is a light collection region (101); a light processing region (102), which itself contains a phase shifting region (103) and an optical transformation region (105); and an image formation region (107). The light collection region (101) has a plurality of first light couplers (110). The light processing region (102) has a plurality of input waveguides (120), a plurality of phase shifters (130) along these waveguides, an optical processing module (105), a plurality of output waveguides (160), and light detectors (170). The devices can be substantially planar, meaning the elements and regions can be implemented in or on a planar surface, for example in or on a thin integrated photonic chip.

FIG. 5 shows 5×5=25 light input couplers (110-1, 2, . . . , 25). Matching this two-dimensional grid of input couplers, there are also 25 phase shifters (130-1, 2, . . . , 25), and 25 light detectors (170-1, 2, . . . , 25). The couplers are arranged in a 2 dimensional grid in order to capture two dimensional images. One index number is for the vertical x-axis, it is marked by “nx=−2, −1, 0, +1, +2” on the left of FIG. 5. The second index number is for the horizontal y-axis, it is marked by “ny=−2, −1, 0, +1, +2” on the bottom left of FIG. 5. Waveguides (120) connect the input couplers to phase shifters.

Each phase shifters (130) in the phase shift region (103) are configured to apply specifically prescribed phase shifts. In particular, they can apply light phase shifts that correspond to a substantially quadratic function of the position of the grating coupler they are connected to. Using the indexing scheme shown in the figure with two index numbers nₓ and n_{y}, and defining the center of the array to be at nₓ, n_{y}=0, the position of the coupler (nₓ, n_{y}) is given by x=nₓhₓ and y=n_{y}h_{y}, where hx and hy are the distances between the input couplers in the vertical and horizontal direction. Each phase shifter then applies a phase shifts prescribed as in equation (4)

$$Δθ ( {n}_{x} , {n}_{x} ) = {θ}_{0} - \frac{π {{h}_{x}}^{2}}{λ L} {{n}_{x}}^{2} - \frac{π {{h}_{x}}^{2}}{λ L} {{n}_{y}}^{2} . \qquad ( 4 )$$

Here Δθ is the prescribed phase shift, nx, ny are the x and y indexes as described above, L is the distance between the imager and the object as previously, and λ is the wavelength of light. (The parameter θ₀ is a nominal offset that can be selected as convenient.)

Table 2 below lists numerical values of example prescribed phase shifts for the phase shifters (130) of FIG. 5. They are listed versus the indexes nₓ and n_{y}, for the case when the object (OB) is L=1 meter away from the imaging device, the spacing between input couplers in the vertical and horizontal directions is hx=hy=50 micrometers, a wavelength of light λ=532 nanometers is considered, and the nominal offset angle θ₀ is set to zero.

TABLE 2
Exemplary prescribed phase shifts (in degrees) for the phase shifters
(130-1, 2, . . . , 25) of the 5 × 5 pixel device of FIG. 5.

| | ny | | | | |
|---|---|---|---|---|---|
| nx | +2 | +1 | 0 | −1 | −2 |
| +2 | −6.77 | −4.23 | −3.38 | −4.23 | −6.77 |
| +1 | −4.23 | −1.69 | −0.85 | −1.69 | −4.23 |
| 0 | −3.38 | −0.85 | 0.00 | −0.85 | −3.38 |
| −1 | −4.23 | −1.69 | −0.85 | −1.69 | −4.23 |
| −2 | −6.77 | −4.23 | −3.38 | −4.23 | −6.77 |

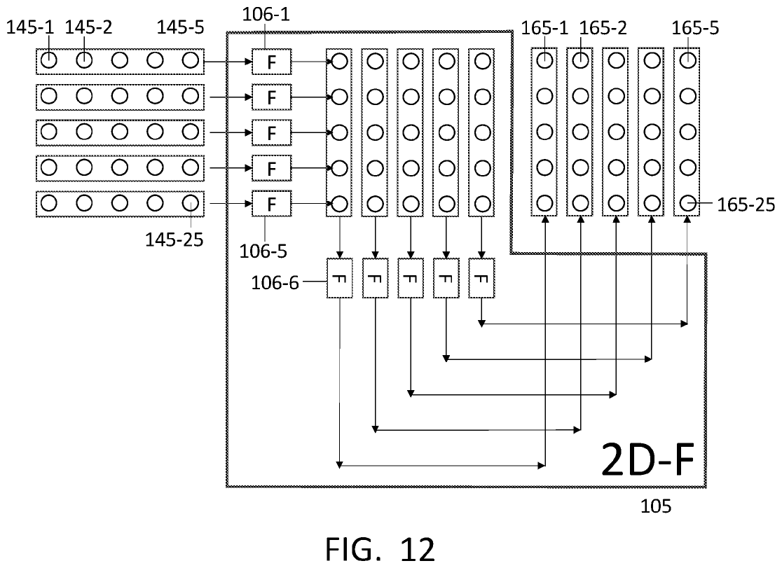

Next, for FIG. 5, the optical processing module (105) now operates on signals in two spatial dimensions. It now applies a 2-dimensional Fourier transform. Prior art in the field of integrated photonics has shown how to implement 1-dimensional Fourier transforms using a combination of beamsplitters and phase shifters. Notable prior art includes Mahric (“Discrete Fourier transforms by single-mode star networks”, Vol. 12, Issue 1, pp. 63-65 (1987), https://doi.org/10.1364/OL.12.000063) and Siegman (“Fiber Fourier optics”, Vol. 26, Issue 16, pp. 1215-1217 (2001), https://doi.org/10.1364/OL.26.001215). These works show how to build the 1-dimensional Fourier transforms from phase shifters and beamsplitters. It is disclosed that a 2-dimensional Fourier transform can be decomposed into a sequence of 1-dimensional Fourier transforms. Specifically, a two dimensional Fourier transform can be achieved by applying a one dimensional Fourier transform on each row of signals, followed by a one dimensional Fourier transform on the columns of the signals. FIG. 12 schematically illustrates this method to implement a two-dimensional Fourier transform. In the figure, 5×5 input waveguide entry locations are shown (145-1, 145-2, . . . , 145-25). Light from the input waveguides enters the optical processing module (105), which is now configured to perform a 2-dimensional Fourier transformation (‘2D-F’). To perform this 2-dimensional Fourier transform, there is a sequence of 1-dimensional Fourier transformation modules (‘F’, 106-1, 106-2, . . . , 106-5, 106-6, . . . ), each of which can be constructed by methods already known in the art (e.g. Mahric, Siegman). The connection network shown within 105 (‘2D-F’) can perform such a 2-dimensional Fourier transform. The output of this 2-dimensional Fourier transform is directed to 5×5 waveguide output locations (165-1, 165-2, . . . , 165-25), and exit waveguides carry the transformed light out. This is only one exemplary method and there may be other methods to implement a two dimensional Fourier transform. Other two-dimensional transforms (for example to enable imaging outside the paraxial limit) can be similarly implemented on a photonic chip or substrate (100).

Light detectors for FIG. 5 can be realized in a similar way to for FIG. 1. They could be arranged in a 2-dimensions grid as shown in region 107 of FIG. 5. Or they can be unwrapped into one long array and edge-coupled to the substrate, so long as the exit waveguides are routed so that each waveguide connects to the correct detector. The light detectors could be composed of any element that converts light to electrical signal, such as CCD (charge coupled device) arrays, CMOS (complementary metal-oxide-semiconductor) arrays, avalanche photodiodes, or bolometers. Other elements that can measure light could also be used. The detectors could be placed on the substrate (100) as illustrated in FIGS. 1 and 5. Or they could be placed next to the edge of the substrate (butt-coupled to it).

Overall, the imager elements and their arrangement are similar for imaging in 1 versus in 2 spatial dimensions (compare FIG. 1 to FIG. 5). The key expansions to enable 2-dimensional imaging are: The input couplers (110) are now arranged in a 2-dimensional grid. The quadratic phase shifts relation is over two spatial indexes instead of just one (equation 4 instead of equation 1). The optical transformation (105) is also over 2 dimensions (instead of only 1 dimension).

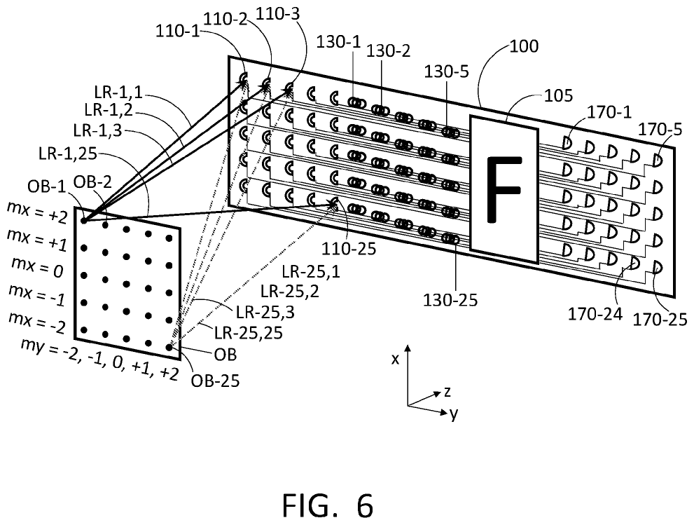

Now FIG. 6 is used to explain the progression of light through the device of FIG. 5, for 2-dimensional imaging. Again, this explanation is for the case when the imager is operating with the paraxial limit (the object OB is sufficiently far away from the imager). The object (OB) has 25 points (OB-1, . . . , 25).

Light is emitted from each point on the object (OB) and is incident on the chip. Thus light from each point on the object can reach each collecting coupler on the chip. For example, light from point OB-1 can reach all collecting couplers (labeled 110-1, 110-2, through 25). However, to not clutter the illustration, only 4 of these light ray arrows are shown (i.e. LR-1,1, LR-1,2, LR-1,3 and LR-1,25, to input couplers 110-1,2,3,25). Likewise, for the last shown source point on the object (OB-25), also only 4 of the light rays are shown (i.e. LR-25,1, LR-25,2, LR-25,3, LR-25,25, shown as thin dashed lines, to input couplers 110-1,2,3,25). However, even though only 4 light rays are shown for only 2 points, it is understood that many or all point sources on the object can send light to many or all input couplers on the chip.

Points on the object are indexed by mx=−2, −1, 0, +1, +2 in the x (vertical) direction, and by my=−2, −1, 0, +1, +2 in the y (horizontal) direction. While dual indexing (nx and ny) for the imager channels is as shown in FIG. 5. The object is composed of many points, and the twenty-five points are for illustrative purposes.

First consider light rays from a point source on the object with indexes mx=0 and my=0. Light from this central point arrives at the couplers (110) with nearly equal amplitude, but with varying phase. This is because the light path from the source to each coupler has slightly different path length.

One can show that in the paraxial limit the relative phase Δϕ(nₓ, n_{y}) of the light exciting coupler nx, ny (i.e. the phase difference between the light at coupler nx≠0, ny≠0 and the coupler nx−0, ny=0) are given by the quadratic function

$$Δϕ ( {n}_{x} , {n}_{y} ) = \frac{π {{h}_{x}}^{2}}{λ L} {{n}_{x}}^{2} + \frac{π {{h}_{x}}^{2}}{λ L} {{n}_{y}}^{2} ,$$

where hₓ and h_{y} are the distances between adjacent couplers along the x and y axis, L is the distance between the source at mx, my=0 and the coupler nx, ny=0, and λ is the wavelength of light. To compensate for these different phase shifts we set the phase shifters to apply the phase shift Δθ(nₓ, n_{y}) given by the equation (4) previously. (The parameter θ_{θ} is a nominal offset that can be selected as convenient, and will not affect the operation of the device.)

A quadratic relation is one example, which is the appropriate relation in the paraxial limit for an object that emits light at a well-defined wavelength A. There can be other relations (e.g. higher order polynomials, trigonometric functions, conic functions, etc.) that will give a distribution of phase shifts that are approximately or substantially equal to the phase shifts specified by a quadratic relation. Or the relation can be defined by selecting it so that it will substantially compensate for the variation in light path length from a location on the object to the input couplers. Using such alternate/nearby relations is anticipated and disclosed.

Now consider the other mx≠0, my≠0 points on the object (OB). In the paraxial limit, the source corresponding to indices mₓ and m_{y} generates light in all of the waveguides of nearly equal amplitude, but with unequal phases. After the phase shifter array (130) which applies the quadratic phase shift of equation (4), then the relative phase between the light in channel nx, ny≠0 and the light in channel nx, ny=0 is given by

$$ΔΦ = - \frac{π {h}_{x} {H}_{x}}{L λ} {m}_{x} {n}_{x} - \frac{π {h}_{y} {H}_{y}}{L λ} {m}_{y} {n}_{y}$$

where Hₓ and H_{y} are the distances between the object light sources along the x and y axis, and all other parameters are as previously defined.

Image focusing will occur if system parameters are selected to satisfy the equation

$$L = \frac{{N}_{x} {h}_{x} {H}_{x}}{2 λ} , L = \frac{{N}_{y} {h}_{y} {H}_{y}}{2 λ} \qquad ( 5 )$$

where Nₓ and N_{y} are the total number of couplers in the imager along the x and y axis. The condition specifies the distance at which the imaging system can generate a sharp image along the x and y axis. Objects outside this distance (outside the focal plane) will be out-of-focus. The focusing condition in Eq. 5 imposes the additional constraint NₓhₓHₓ=N_{y}h_{y}H_{y}, which states that the aspect ratio of the field of view of the object is equal to the ratio of spacing of the couplers along the x and y direction.

Next the optical processing module (105) translates input relative phases into output waveguide selection. Meaning, (105) will send each relative phase to a different output waveguide. Hence each location on the object will be sent to a different detector. This is explained next, in the context of 2-dimensional imaging when the paraxial limit holds (the object is far enough away).

Using the focusing condition of equation (5), the relative phase between the waveguides (140) entering the optical processing module is given by the relation

$$ΔΦ = - \frac{2 π}{{N}_{x}} {m}_{x} {n}_{x} - \frac{2 π}{{N}_{xy}} {m}_{y} {n}_{y} .$$

It is proportional to the source indices mx my, meaning it is proportional to the location on the object. The optical processing module (105) performs a two-dimensional discrete Fourier transform that relates the input and output waveguides by

$$g [ {n}_{x} , {n}_{y} ] = {\sum }_{j , k = 0}^{N} f [ j , k ] {e}^{i \frac{2 π}{{N}_{x}} j {n}_{x} + i \frac{2 π}{{N}_{y}} k {n}_{y}} \qquad ( 6 )$$

In the above equation f[j, k] is the amplitude of the field amplitudes in waveguides that enter the Fourier module (‘F’, 105), and g [nₓ, n_{y}] is the field amplitude propagating in waveguides that exit out of the Fourier module. Here the indexes j and k are summation indices that vary over all of the input waveguides to the optical processing module.

The disclosure also encompasses scenarios wherein the processing module implements transformations distinct from the Fourier transform, yet effectively concentrates light from an individual point on the object primarily onto a singular waveguide. This is anticipated for the case when the imaging system operates beyond the paraxial limit, and where alternative transformations may offer enhanced imaging outcomes. Further, adjustments to the transformation capability of the processing module could rectify aberrations arising from deviations from the paraxial limit, or can correct imperfections in phase shifts or other potential distortions. Adjusting the optical processing module (105) away from a Fourier transformation is disclosed and anticipated herein.

Points located on the object at positions x>hₓNₓ/2, x<−hₓNₓ/2, y>h_{y}N_{y}/2, and y<−h_{y}N_{y}/2 can wrap on the image sensor. This effect can be eliminated by using couplers that selectively couple a restricted range of angles. This ensures that object points beyond the so defined field of view do not effectively transmit light to the couplers.

The employed photonic components (couplers, waveguides, phase shifters, beamsplitters) can take various forms. Light couplers can take the form of grating couplers, where the parameters of the coupler (spacing, width, etc.) are selected to couple incoming incident light into a connected waveguide.

Phase shifters (also sometimes referred to as optical phase shifters, waveguide phase shifters, delay lines, or photonic phase shifters) can be fixed or tunable, and both types can be used in the disclosed imager and projector embodiments. Tunable phase shifters allow dynamic control over light phase shifts. It is disclosed that tunable phase shifters can be used to change the properties of the imaging or projection embodiments, e.g., without moving parts. For example, phase shifter tuning could be used to change imager and projector focus. If the object is a first distance L1 from the chip, then the phase shifts Δθ could be selected according to equation (1) or (4) with L=L1 in the equation. If the distance to the object changes to a second distance L2, then the phase shifts Δθ could be re-selected to match L=L2 in equation (1) or (4). Other properties of the imager could also be changed by tuning the properties of the phase shifters, or of other photonic elements.

Beamsplitters can be made in a variety of ways. Directional coupler beamsplitters can be made by bringing two waveguides into close proximity, so that light from one waveguide couples to the other. Other types of beamsplitters include Y-junction beamsplitters, Mach-Zehnder interferometer-based beamsplitters, multimode interference (MMI) beamsplitters, ring resonator beamsplitters, and grating-based beamsplitters.

In certain imaging contexts, scenes consist of objects radiating or reflecting light of varying colors (i.e. different wavelengths). It can be advantageous to target specific wavelength ranges, thereby optimizing the device performance. To select specific wavelength ranges, filters can be positioned at the primary input waveguides, preceding the detectors, or at other designated locations within the device. These filters are designed to permit the passage of desired wavelength ranges while blocking others. Such filters can be implemented in a variety of ways including ring resonators, Bragg filters, photonic crystal filters, color glass filters, among other ways.

In some cases, capturing multiple wavelength ranges is desirable. For instance, a color imaging device might encompass red, green, and blue channels to produce color images. In such situations, a combination of filters can be employed to differentiate and direct these wavelength ranges to different detectors. Alternatively, a single tunable filter may be used instead of multiple fixed filters. In other instances, several imagers, each equipped with distinct filters, can operate concurrently to capture a range of wavelengths. It is disclosed that a variety of methods can be employed to implement on-chip filters. For example, filters can be realized through optical resonators, such as ring resonators. Alternately, Bragg filters or gratings can be utilized as filters. These examples are among numerous techniques available for selectively isolating specific wavelength ranges.

The imaging chip or mounted substrate or substrate 100 can be integrated in a variety of devices (e.g., camera) to capture an image. A display device can have a chassis, the substrate 100 is mounted in the chassis; and the device can include a processor, memory, a battery, and other components of such devices. The image from the plurality of detectors or sensor(s) can be operatively connected to memory, to a processor, to a display, or can be sent to another device. This is known in the art. The memory can store the image. Additional modules can include instructions that configure the processor to perform various image processing and device management tasks. Working memory may be used by the processor to store and execute instructions, such as user inputs.

### Verification of Two-Dimensional Imaging

This section verifies that two-dimensional photonic imaging functions as intended. To do so, a detailed ray tracing calculation was performed. Ray tracing is a common computational method extensively employed in optics to simulate the behavior of light rays as they interact with optical components. By modeling the effect of each component on incoming and outgoing light rays, ray tracing traces the paths of individual light rays to predict their propagation from an object, through complex optical systems, and to the detection plane. This method is recognized to be accurate due to its foundation in fundamental principles of geometric and wave optics, and can capture intricate phenomena such as aberrations, image formation, and light distribution. Ray tracing is accepted as a valid predictor of real-world optical system performance, facilitating the design and optimization of optical devices with a high degree of precision and fidelity.

The ray tracing software used was written in Octave. The object was simulated using a matrix of 256×256 object points. Each object point launched a fan of rays to each input coupler, exciting with a phase proportional to the propagation distance from the object point to the that input coupler. The intensity of the field in the waveguide was proportional to the light intensity of the object point. As with all conventional imaging systems, each object point was assumed to be an incoherent emitter and therefore the fields originating from different object points add in intensity.

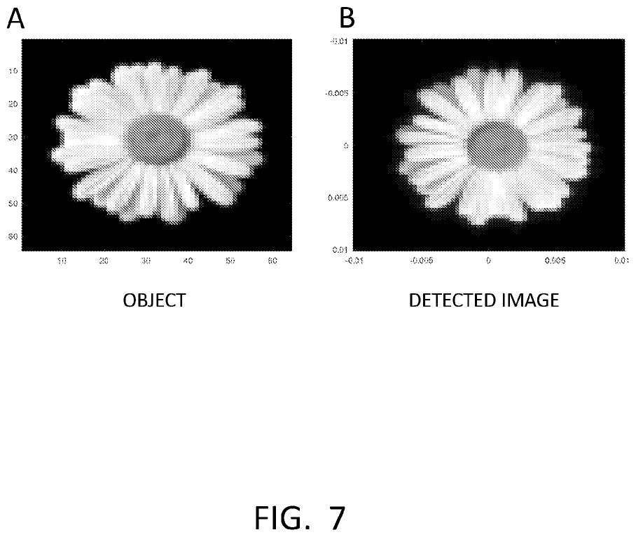

The object to be imaged is shown in FIG. 7A. It is a 1×1 cm object (a daisy flower) located a distance of L=1 meter from the two-dimensional imager. This imager has 64×64=4,096 channels or pixels. Meaning, it contains 64×64 input light couplers, connected to 4,096 waveguides that deliver light to 64×64 phase shifters. The phase shifters apply phase shifts according to the two-dimensional quadratic relation stated in equation (4). Waveguides exiting these phase shifters are connected to an optical processing module that takes in 4,096 inputs, performs a discrete two-dimensional Fourier transform, and returns 4,096 output to outgoing waveguides. These outgoing waveguides deliver light to 4,096=64×64 sensor pixels. The example parameters of the imager are as before: the vertical and horizontal spacing between input couplers is hx=hy=h=50 micrometers. The wavelength of light was set to λ=532 nm.

The resulting image formed by this 64×64 sensor is shown in FIG. 7B. It can be seen that the imager faithfully captures the image of the daisy flower object. It does so to within the 64×64 pixel resolution of the sensor.

The above image processing, from object to image, can be accomplished by a thin chip or substrate imager (100), as illustrated for example in FIG. 6. Hence the disclosed thin imagers could potentially be used to enable thin cameras, since the other components of such a camera (thin sensors, thin displays, thin or compact batteries, compact user interface) are already known in the art of mobile devices and smart phone cameras.

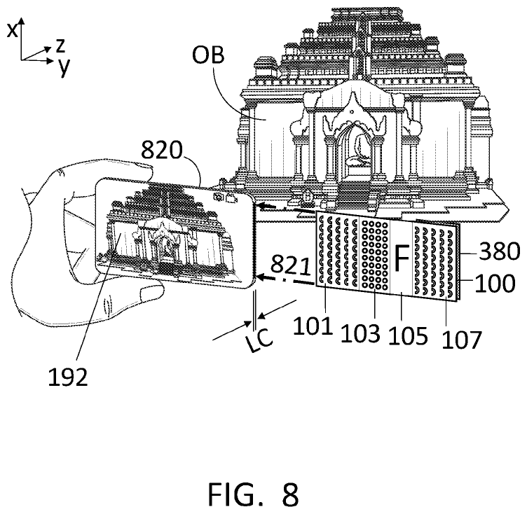

FIG. 8 illustrates a user taking a photograph (192) of an object (OB, the building) or scene with a thin camera (820), that could be enabled by a thin imaging system (100) replacing the conventional optics (lenses, and space between them and the image sensor) that are currently employed in cameras.

### Projection Examples

Projecting or image projection refers to projecting an image on a flat or curved surface at a distance from the device. An example of image projection is a movie projector, which projects an image from the device to the movie screen. A projector and a display operate differently. In a projector, an in-focus image is projected a distance from the device to a surface, like a movie projector that is at one location but projects the movie onto a screen or a wall at another location. Whereas a display forms an in-focus image at a surface of the device, for example like on a laptop screen.

The imaging embodiments herein can be modified and operated in reverse, to enable image projection. Specifically, in an imager, light progresses from the scene, is coupled into the plane of the chip or substrate by light couplers, and is then processed in-plane by waveguides, phase shifters, and an optical processing module (e.g. a module that applies a Fourier transform). By this process, light from a scene or object is converted to an in-focus image on the detectors or sensor, in a thin system, without a need for lenses or curved mirrors.

However, the progression of light through photonic couplers, waveguides, phase shifters and a transform region (e.g. a Fourier transform region) is symmetric forward to backwards. This is due to light time-reversal symmetry, a fundamental principle in optics, which asserts that light waves exhibit a reciprocal behavior when traversing the type of photonic components used herein. This symmetry implies that light will propagate along the same path when traced in reverse. Hence if light detectors are replaced by light sources (e.g. by LEDs (light emitting diodes), by lasers, or by other light sources) then light would propagate from these light sources to the object plane along the same paths as it did when traveling from the object plane to the detectors. Thus a screen were placed at the object plane, then such a device could project an image onto that screen.

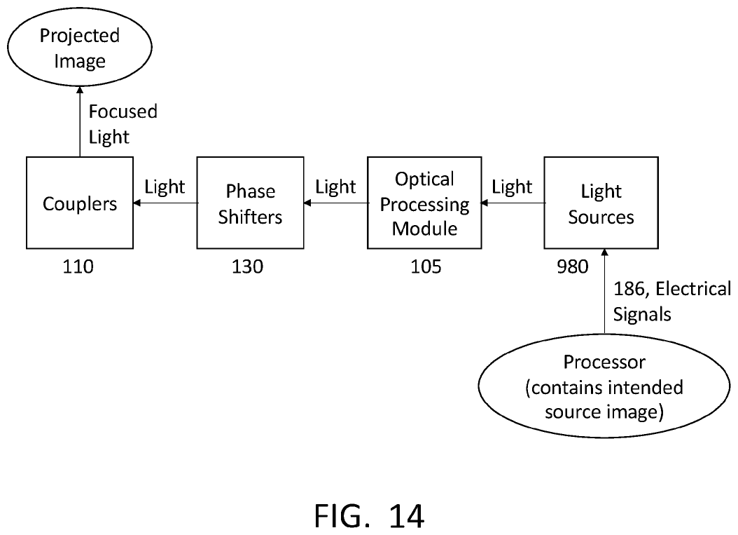

FIG. 14 shows an exemplary method for projecting an image. The steps can include generating an intended source image on a processor; transmitting the intended image to a plurality of light source elements 980 via electrical signals (186); transmitting the light from the sources through a plurality of waveguides to an optical processing module 105, wherein the optical processing module can have input waveguides, output waveguides, and internal beamsplitters and phase shifters, phase shifters and can transform the light; transmitting the light to a plurality of first optical phase shifter elements 130 using a plurality of waveguides; and transmitting the light through waveguides to a plurality of couplers 110 that generate focused light, and that can project an in-focus image.

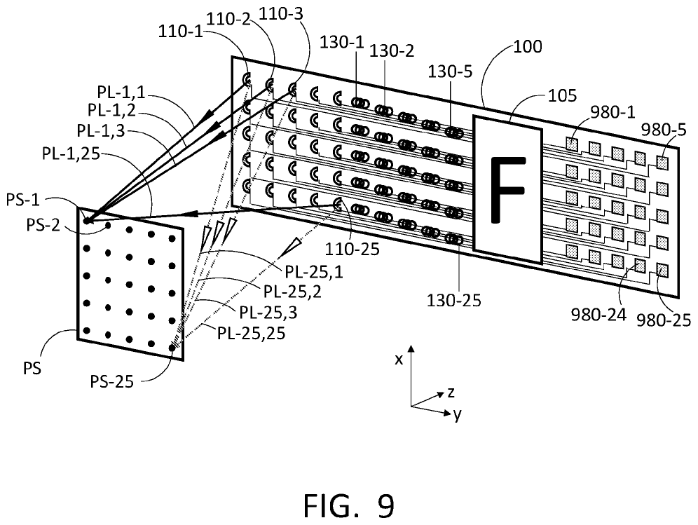

FIG. 9 shows a representative embodiment of a projection system mounted on a planar chip or substrate (100). This embodiment is analogous to the imager of FIG. 6 but the detectors (170-1, 2, . . . , 25) have been replaced by on-chip light source elements (980-1, 2, . . . ,25) to enable projection.

Light now propagates in reverse (from right to left) in FIG. 9, but otherwise traces the same paths as in FIG. 6. Specifically, if one light source is turned on then light from that source will travel through the system of FIG. 9, will exit from substantially all light couplers (110), and will arrive in-focus at substantially a single point on the projection screen (PS). For example, if the first light source (980-1) is turned on, that light will travel through the Fourier region (‘F’, 105), through the phase shifters (130), will exit out from substantially all light couplers (110), and will arrive at substantially one point (PS-1) on the projection screen (PS). Hence the projected light rays (PL-1,1, PL-1,2, . . . , PL-1,25) will now travel in the reverse direction (from the light couplers (110) to the projection screen (PS)) but will otherwise trace the same path as shown by light rays (LR-1,1, LR-1,2, . . . , LR-1,25) in FIG. 6. Thus if the multiple light sources (980-1, 2, . . . , 25) are turned on to create an image, that image will be cast in-focus onto the projection screen (PS).

Overall, the elements of the projection embodiment shown in FIG. 9 are similar to the elements of the prior imaging embodiments shown in FIGS. 1-6. Since the progression of light through the device is in the reverse order compared to imagers, the elements are discussed in the reverse order. The light source elements (980) can be broadband sources, such as LEDs (light emitting diodes), or micro-LEDs (small LEDs) or thermal light sources. They can also be narrowband light sources such as laser light sources, including laser diodes, on-chip lasers, or light sources that make use of quantum dots or nanoparticles to create a narrowband source of light. Or they can be other light sources known in the fields of photonics. The light sources could be light emitting devices integrated directly into the flat mounting substrate (as illustrated in FIG. 9), or they could be implemented off chip and could couple into the mounting substrate (100) by couplers. The light sources can be turned on or off, per input pixel, to varying levels of intensity, to create the desired image that will be projected. Light sources can also be provided in one or different colors.

Next, the optical processing module (105) can be the same as disclosed above for imagers. In particular, it implements a 2-dimensional discrete Fourier transform. The 2-dimensional array of phase shifters (130) can also be the same as disclosed above for imagers. In particular, it can apply a phase shift that is a quadratic function of the position of the output coupler, as previously disclosed in equation (4).

The above embodiment will project an in-focus image on the projection plane in the paraxial limit. It will still function outside the paraxial limit but with potentially degraded performance. As previously for imagers, the quadratic relation and Fourier transform can be modified to potentially achieve improved performance outside the paraxial limit, or to to rectify imperfections in phase shifts, or potential distortions. Doing so is anticipated and disclosed.

The light couplers (110) of FIG. 9 can be the same or similar as previously disclosed for imagers. But compared to FIG. 6 where they are operated as input couplers, here in FIG. 9 they are operated as output couplers. As noted earlier, it can be the same physical element (same coupler) repeated multiple times. Due to light time-reversal symmetry, if light is sent into this coupler by a waveguide, then it will exit the chip or substrate (100) as projected light rays (labels PL in FIG. 9). These exit projected light rays will form an in-focus image on the projection surface (PS).

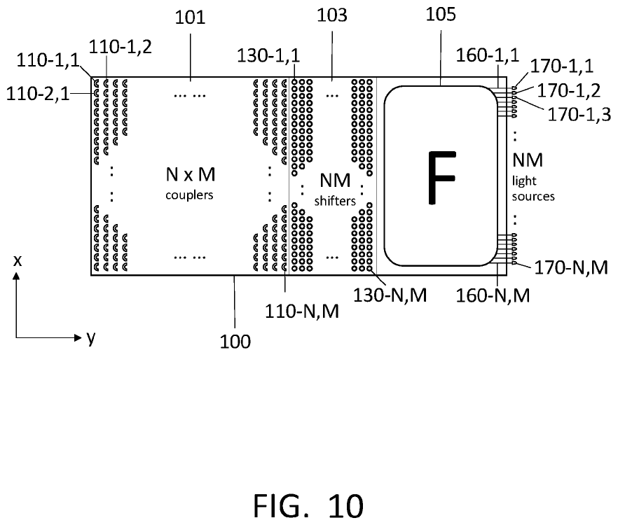

More light sources or pixels may be needed for improved imaging. FIG. 10 shows a further embodiment of image projection. This figure shows that the number of pixels can be large.

Specifically, it shows an embodiment with N×M pixels. Again, there is an integrated photonic component composed of a mounting substrate (100). On or in this substrate are arranged N×M light couplers (110-1,1, 110-1,2, . . . , 110-N,M) in a light collection region (101). Since photonic light couplers can be small (e.g., in the range of 2 to 50 micrometers), hence many such couplers can be placed on a chip region, thus N and M can be large. For example, a 3.8 cm×2.2 cm ship with output coupler density of 20 μm could potentially support 1920×1080 pixels, and therefore be able to display 1080p video format.

This embodiment also includes a phase shifting region (103) with N×M phase shifters (130), which can also be small. As noted earlier, the amount of phase shifts can be arranged to follow a quadratic relation according to equation (4). Then there is an optical processing module (105) which can be configured to perform a two-dimensional Fourier transform.

In this embodiment the connected N×M light source elements (170) have been unwrapped into a single array, and are shown butt-coupled to the edge of the chip or substrate (100). This is disclosed as an option, and it is understood that the connecting waveguides (160) from (105) to (170) are appropriately routed to accommodate a single array of butt-coupled light sources. Light sources such as micro-LEDs can be small, and hence many can be used. Alternatively, if instead on-chip light sources are used (such as on-chip lasers), then they can be arranged in the grid pattern shown previously in FIG. 9 (labels 980). In this case, many light sources can also be used.

The image to be projected can be generated by a plurality of light sources. A collection of light sources is known in the art, and can be also referred to as a display. Light sources can be connected to memory, to a processor, or to another device. The memory can store the image to be projected. Additional modules can include instructions that configure the processor to perform various image processing and device management tasks. Working memory may be used by the processor to store and execute instructions, such as user inputs

### Verification of Two-Dimensional Projecting

This section verifies that 2-dimensional photonic projection functions as intended. To do so, a detailed full-wave calculation was performed using software that was written in Octave. The simulation was performed for the device shown in FIG. 10, with N×M=64×64 device channels or pixels. The field emitted by each coupler (by 110-1,1, . . . , 110-64,64 in FIG. 10) was simulated as a spherical electromagnetic wave, which is an accurate approximation in the paraxial limit. The intensity of each light source was set to the pixel value of the image to be projected. Then light progression was simulated through the 2-dimensional Fourier transformation of optical module (105) and through the phase shifter elements (130-1,1, . . . , 130-64,64) in region 103. The parameters of the projection embodiment were set to be hₓ=h_{y}=50 μm, L=50 μm, and λ=532 nm.

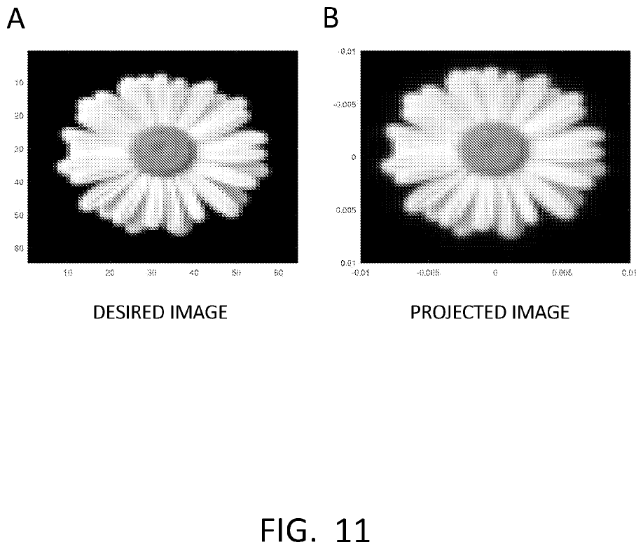

The image to be projected is shown in FIG. 11A. It is a 64×64 pixel image (a daisy flower). The image is a grayscale representation measuring 64×64 pixels, designed to be input into a projection system comprising an equivalent number of light sources. Light rays from light sources that implement this image are subject to a simulation through the type of projection embodiment shown in FIGS. 9 and 10. This projector has 64×64=4,096 channels or pixels (N=M=64). Meaning, it contains 64×64 input light sources, connected to a optical processing module that takes in 4,096 inputs and returns 4,096 outputs. This is connected by waveguides to 64×64 phase shifters. The phase shifters apply phase shifts according to the 2-dimensional quadratic relation stated in equation (4). Waveguides exit these phase shifters and connect to 64×64 output couplers. Light exits from these couplers and is focused on an external projection screen. The projection field of view is a 1 cm×1 cm square on the projection plane.

The resulting image formed by this 64×64 array of light sources is shown in FIG. 11B. It can be seen that the projector faithfully projects the image of the daisy flower. Each light source is a pixel to be projected on a plane. The above image projection, from intended image to projection screen, can be accomplished by a thin chip or substrate (100), as illustrated in FIG. 9. A potential use for such on-chip projectors is in augmented or virtual reality applications. A projection chip or chips could be attached to glasses, visors, or headsets, and could be used to project images into the user's eye or eyes.

Projection has the property that the projected image can repeat outside the field of view. Specifically, the image outside the simulated 1 cm×1 cm field of view will have copies of the daisy picture. This effect can be eliminated by using couplers that selectively couple a restricted range of angles. This ensures that light is not projected beyond the desired field of view. Methods to control the angular sensitivity of the coupler are well known, and the angular sensitivity can be controlled very accurately by proper computational design of the coupler shape.

Optical path length (OPL) is a concept used in optics to describe the length of the path that light travels through a medium. It is the product of the physical distance that light travels and the refractive index (or index of refraction) of the medium it passes through.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. Overall, the embodiments herein were chosen and described in order to explain the principles of the invention and its practical application to enable one skilled in the art to utilize the invention in various embodiments. Modifications as are suited to the particular use contemplated are anticipated, and are covered by this disclosure.

What is claimed:

1. A mounting substrate to capture a scene, comprising
a plurality of first couplers that capture incident light on the substrate from the scene;
a plurality of input waveguides receives the incident light, wherein each of the plurality of the first couplers guide the light into one of the plurality of input waveguides;
a plurality of first optical phase shifter elements shift the phase of the light to produce phase shifted light; wherein the phase shift compensates for the variation in optical path length from a point on the object or the scene to the plurality of the first couplers and through the first waveguides;
an optical processing module that transforms the phase shifted light into focused light;
a plurality of output waveguides captures an in focused light; and
a plurality of detectors captures the focused light to form an image.

2. A substrate of claim 1, wherein the optical processing module has internal waveguides, internal phase shifters, and internal beamsplitters therein, the optical processing unit receives the shifted light; and the optical processing unit transforms the shifted light into in a focused light.

3. A substrate of claim 1, wherein the optical processing module has internal multi-mode interference devices therein, the optical processing module receives the shifted light; and the optical processing module transforms the shifted light into in a focused light.

4. A mounting substrate of claim 1, wherein the substrate forms the image at the detectors using the light directly captured from the scene by the plurality of first couplers.

5. A mounting substrate of claim 1, the substrate forms the image using the light captured by the plurality of first couplers and the plurality of first optical phase shifter elements and the plurality of detectors.

6. A mounting substrate of claim 1, wherein the plurality of first couplers captures the incident light without a lens.

7. A mounting substrate according to claim 1, wherein the plurality of phase shifters produce a phase that is a quadratic function of the position of the plurality of first couplers that feeds light into the plurality of phase shifter.

8. A substrate according to claim 1, wherein the optical processing module performs a discrete Fourier transform.

9. A substrate according to claim 1, wherein the optical processing module is composed of internal beamsplitters, internal phase shifters, and internal waveguides.

10. A mounting substrate of claim 1, wherein the first plurality of optical phase shifters are configured to apply a phase shift which is a quadratic function of the position of the coupler that feeds the respective phase shifter.

11. A mounting substrate of claim 1, wherein the plurality of input couplers is evenly spaced along the substrate and the phase shifters apply phase shifts that are a quadratic function of the distance from one of the couplers.

12. A mounting substrate according to claim 1, wherein the first optical phase shifters are configured to apply phase shifts of
Δθ=π/λLx²+π/λLy² where x is the distance from the along the x-axis from the plurality of the first couplers to one of the plurality of the first couplers, y is the distance from the along the x-axis from one of the plurality of the first couplers to a first coupler of the plurality of couplers, L is the distance from the substrate to an object plane in the scene that will form a focused image, and is the wavelength of light.

13. A mounting substrate of claim 1, wherein the light reflects or emanates from the object to the plurality of first couplers.

14. A mounting substrate of claim 1, wherein each of the plurality of first couplers corresponds one of the plurality of plurality of first optical phase shifter elements and one of the plurality of input waveguides.

15. A mounting substrate of claim 1, wherein the substrate is flat.

16. A mounting substrate of claim 1, wherein the plurality of first couplers, the plurality of input waveguides, and the plurality of first optical phase shifter elements are disposed on one plane on the substrate.

17. A mounting substrate of claim 1, wherein the plurality of detectors are butt-coupled next to the substrate.

18. A mounting substrate of claim 1, wherein the array of first couplers couple light from an object into an array of waveguides, followed by an array of phase shifters that adjust the phase of the field in each waveguide, followed by a series of beamsplitters and phase shifters to form an image at an output set of waveguides.

19. A mounting substrate of claim 1, wherein each of the plurality of input couplers has different portion of the scene.

20. A substrate of claim 1, wherein the plurality of detectors receive light from couplers on the substrate.

21. A mounting substrate of claim 1, wherein a plurality of input waveguides are configured to direct light to the a plurality of first optical phase shifter elements.

22. A mounting substrate of claim 1, wherein the detector is an image sensor.

23. The mounting substrate of claim 1, where a series of spectral filters select different color light before the detector

24. An imaging device comprising
a chassis;
a mounted substrate to capture a scene having (i) a plurality of first couplers that capture incident light on the substrate from the scene; (ii) a plurality of input waveguides receives the incident light, wherein each of the plurality of the first couplers guide the light into one of the plurality of input waveguides; (iii) a plurality of first optical phase shifter elements shift the phase of the light to produce phase shifted light; wherein the phase shift compensates for the variation in light path length from a point on the object or the scene to the plurality of the first couplers and through the first waveguides; (iv) an optical processing module having input waveguides, output waveguides, wherein the optical processing module transforms the phase shifted light into focused light; (v) a plurality of output waveguides captures an in focused light; and (vi) a plurality of detectors captures the focused light to form an image processor; and
memory.

25. An imaging device of claim 24, wherein the mounted substrate does not have an operatively connected lens.

26. An imaging device of claim 24, wherein the imaging device is a camera.

27. An imaging device of claim 24, wherein the optical processing module has internal waveguides, internal phase shifters, and internal beamsplitters therein, the processing module receives the shifted light; and the optical processing module transforms the shifted light into in a focused light.

28. An imaging device of claim 24, the substrate forms the image using the light captured by the plurality of first couplers and the plurality of first optical phase shifter elements and the a plurality of detectors.

29. An imaging device of claim 24, wherein the plurality of first couplers captures the incident light without an operatively connected lens.

30. An imaging device of claim 24, wherein the phase shifters produce a phase that is a quadratic function of the position of the coupler that feeds light into the phase shifter.

31. An imaging device of claim 24, wherein the optical processing module performs a discrete Fourier transform.

32. An imaging device of claim 24, wherein the optical processing module is composed of beamsplitters, phase shifters, and waveguides.

33. An imaging device of claim 24, wherein the first plurality of optical phase shifters are configured to apply a phase shift which is a quadratic function of the position of the coupler that feeds the respective phase shifter.

34. The imaging device of claim 24, wherein the optical processing module is composed of multi-mode interference devices.

35. An imaging device of claim 24, wherein the first optical phase shifters are configured to apply phase shifts of
Δθ=π/λLx²+π/λLy² where x is the distance from the along the x-axis from the plurality of the first couplers to one of the plurality of the first couplers, y is the distance from the along the x-axis from one of the plurality of the first couplers to a first coupler of the plurality of couplers, L is the distance from the substrate to an object plane in the scene that will form a focused image, and is the wavelength of light.

36. The imaging device of claim 24, further comprising a display.

37. The imaging device of claim 24, further comprising a processing module configured to assemble the focused light from the plurality of detectors.

38. The imaging device of claim 24, wherein the plurality of input couplers is evenly spaced along the substrate and the phase shifters apply phase shifts that are a quadratic function of the distance from the center waveguide.

39. The imaging device of claim 24, wherein the unitary implements a Fourier transform of the input field amplitudes.

40. The imaging device of claim 24, further comprising a display and an image sensor, wherein the image sensor is operatively connected to the plurality of detectors.

41. The imaging device of claim 22, where a series of spectral filters filter different color light before each detector.

42. An apparatus for generating one or more Augmented Reality (AR) objects, comprising:
a light source; and
a substrate as claimed in claim 1,

43. A method of projecting an image or scene, comprising:
generating focused light from a plurality of light sources;
capturing the focused light using a plurality of first waveguides;
transmitting the focused light to an optical processing module that transforms the focused light to shifted light;
transmitting the light from the optical processing module to a plurality of phase shifters operatively connected to first output couplers by second waveguides; wherein the phase shifters compensate for the variation in optical path length from the output couplers to a point on projection plane or scene, and the output couplers emit the light to the projection plane or scene to form a focused image.

44. The method of claim 43, wherein the compensation is performed by a plurality of phase shifters.

45. A method of claim 44, wherein the image is formed by capturing and assembling the focused light from the plurality of detectors.

46. A method of capturing an image, comprising:
capturing light using a plurality of input couplers;
compensating for the phase shift acquired by the light as it travels from a location in the scene to the first couplers
transmitting the light to an optical processing module, wherein the optical processing transforms the shifted light into in a focused light;
transmitting the focused light from the optical processing module to a plurality of detectors using a plurality of output waveguides; and
forming an image using the focused light.

47. The method of claim 46, wherein the compensation is performed by a plurality of phase shifters.

48. The method of claim 46, wherein the image is formed by capturing and assembling the focused light from the the plurality of detectors.

49. The method of claim 46, further comprising capturing the focused light to for an image of the scene, wherein the image sensor is a complementary metal oxide semiconductor (CMOS) camera sensor.

50. A mounting substrate to project an image on a plane comprising
a plurality of first light sources that generate focused light on the substrate;
a plurality of input waveguides that receive the generated light;
an optical processing module having second input waveguides, and first output waveguides, wherein the optical processing module transforms the focused light into phase shifted light;
a plurality of first optical phase shifter elements receive the light from the optical processing module and produce a phase shift light; wherein the phase shift compensates for the variation in light path length from a point on the object or the scene to the plurality of the first couplers and through the first waveguides
a plurality of output waveguides receives the light from the phase shifters and emits it out of the plane of the device, wherein each of the plurality of the first couplers projects an image.

51. A substrate of claim 50, wherein the optical processing module has internal waveguides, internal phase shifters, and internal beamsplitters therein, the optical processing module receives the shifted light; and the optical processing module transforms the shifted light into in a focused light.

52. A substrate of claim 50, wherein the optical processing module has internal multi-mode interference devices therein, the optical processing module receives the shifted light; and the optical processing module transforms the shifted light into in a focused light.

53. A mounting substrate of claim 50, wherein the substrate forms the image at the detectors using the light directly captured from the scene by the plurality of first couplers.

54. A mounting substrate of claim 50, wherein the plurality of first couplers captures the incident light without a lens.

55. A mounting substrate according to claim 50, wherein the plurality of phase shifters produce a phase that is a quadratic function of the position of the plurality of first couplers that feeds light into the plurality of phase shifter.

56. A mounting substrate according to claim 50, wherein the optical processing module performs a discrete Fourier transform.

57. A mounting substrate of claim 50, wherein the plurality of input couplers is evenly spaced along the substrate and the phase shifters apply phase shifts that are a quadratic function of the distance from one of the couplers.

58. A substrate according to claim 50, wherein the first optical phase shifters are configured to apply phase shifts of
$$Δθ = \frac{π}{λ L} {x}^{2} + \frac{π}{λ L} {y}^{2}$$
where x is the distance from the along the x-axis from the plurality of the first couplers to one of the plurality of the first couplers, y is the distance from the along the x-axis from one of the plurality of the first couplers to a first coupler of the plurality of couplers, L is the distance from the substrate to an object plane in the scene that will form a focused image, and is the wavelength of light.

59. A substrate of claim 50, wherein each of the plurality of first couplers corresponds one of the plurality of plurality of first optical phase shifter elements and one of the plurality of input waveguides.

60. A substrate of claim 50, wherein the substrate is flat.

61. A substrate of claim 50, wherein the plurality of first couplers, the plurality of input waveguides, and the plurality of first optical phase shifter elements are disposed on one plane on the substrate.

62. A substrate of claim 50, wherein the plurality of detectors are butt-coupled next to the substrate.

63. A substrate of claim 50, wherein the plurality of detectors receive light from couplers on the substrate.

64. The substrate of claim 50, wherein each of the plurality of input couplers has different portion of the scene.

65. The mounting substrate of claim 50, wherein a plurality of input waveguides are configured to direct light to the a plurality of first optical phase shifter elements.

66. The mounting substrate of claim 50, wherein the detector is an image sensor.

67. The mounting substrate of claim 50, where a series of spectral filters filter different color light before the detector.
